(19) United States
(12) Patent Application Publication
(10) Pub. No.: US 2024/0217218 A1
(43) Pub. Date: Jul. 4, 2024

(54) COMPOSITE PRE-COATING FILM AND PREPARATION METHOD THEREOF, AND COMPOSITE FLOOR

(71) Applicant: BANFERT NEW MATERIALS CO., LTD., Hunan (CN)

(72) Inventors: Xinxiong LI, Hunan (CN); Hui LI, Hunan (CN); Shiguo LIU, Hunan (CN); Dongming ZHANG, Hunan (CN)

(21) Appl. No.: 17/914,636

(22) PCT Filed: Aug. 9, 2022
(86) PCT No.: PCT/CN2022/111001

§ 371 Date: Oct. 26, 2023

(30) Foreign Application Priority Data
Apr. 19, 2022 (CN) 202210408598.2

(51) Int. Cl. B32B 27/08; B32B 3/06; B32B 3/30; B32B 5/18; B32B 21/04; B32B 21/08; B32B 27/22; B32B 27/30; B32B 27/32; B32B 27/36; B32B 37/24; C08J 5/12; C08J 7/04; C09D 4/00; C09D 5/00; C09D 123/12; C09D 127/06; C09D 167/02; C09D 175/14; E04F 15/10; E04F 15/18; E04F 15/20

(52) U.S. Cl. CPC B32B 27/08; B32B 3/06; B32B 3/30; B32B 5/18; B32B 21/042; B32B 21/047; B32B 21/08; B32B 27/22; B32B 27/304; B32B 27/32; B32B 27/36; B32B 37/24; C08J 5/124; C08J 7/042; C09D 4/00; C09D 5/002; C09D 123/12; C09D 127/06; C09D 167/02; C09D 175/14; E04F 15/107; E04F 15/181; E04F 15/206; B32B 2037/243; B32B 2255/10; B32B 2255/26; B32B 2255/28; B32B 2307/412; B32B 2323/10; B32B 2327/06; B32B 2367/00; B32B 2419/00; C08J 2323/12; C08J 2327/06; C08J 2367/02; C08J 2423/12; C08J 2427/06; C08J 2467/02

(57) ABSTRACT

The present disclosure relates to the technical field of B29D7/01, and more particularly to a composite pre-coating film and a preparation method thereof, and a composite floor. The preparation method includes the following steps: laminating a polymeric printing film, a polymeric transparent film, and a radiation-cured coating A in sequence. In the present disclosure, the composite pre-coating film has multiple functions through a composite structure design. The radiation-cured coating A provides a desirable abrasion and scratch resistance and gloss; the polymeric transparent film provides an abrasion resistance and flexibility; and the polymeric printing film provides a color pattern effect. After being embossed by an embossing roller, the composite pre-coating film has a three-dimensional simulated pattern effect, as well as excellent wear resistance, scratch resistance, and stain resistance, and can be used to prepare a composite floor with various wood-plastic structures.

### CROSS REFERENCE TO RELATED APPLICATION

The present application claims the priority to Chinese Patent Application No. 202210408598.2, titled “PREPARATION METHOD OF COMPOSITE PRE-COATING FILM, COMPOSITE PRE-COATING FILM AND PREPARATION METHOD THEREOF”, filed with China National Intellectual Property Administration on Apr. 19, 2022, which is incorporated herein by reference in its entirety.

### TECHNICAL FIELD

The present disclosure relates to the technical field of an International Patent Classification (IPC) number B29D7/01, and more particularly to a composite pre-coating film and a preparation method thereof, and a composite floor.

### BACKGROUND

At present, floors on the market mainly include solid wood floors, laminate floors, and plastic floors. The solid wood floor features a stable structure, environmental friendliness and naturalness, and desirable foot feeling, but has a large color difference, complicated surface coating treatment processes, and a relatively high cost. The laminate floor has a low price and an excellent wear resistance, but is controversial due to environmental hostility and formaldehyde production. The plastic floor mainly refers to PVC floors that are very popular in many countries in recent years. The plastic floor has water and moisture resistance, easy pavement, fire resistance and flame retardance, sound absorption and noise prevention, and various patterns and colors. However, compared with wooden floors, the plastic floor shows relatively poor foot feeling and structural stability, and its surface can be easily scratched. Therefore, it is necessary to develop a composite floor that can integrate the advantages while abandoning the disadvantages of the above three types of floors.

Decorative film is a novel decorative material prepared by using high-molecular polymers as a raw material, adding various additives, and conducting calendering or extrusion casting, printing, and compounding. The decorative film can be widely used in the decoration of home appliances, furniture, and walls. Currently, decorative films on the market mainly provide a decorative effect. These decorative films have no coating protection on their surface, or are coated with traditional solvent-based coatings or water-based coatings to provide limited protection. Therefore, such decorative films have an unsatisfactory resistance to scratch, abrasion, and stain, and cannot be used in the fields with a higher requirement in resistance to the abrasion and scratch, such as floors and furniture. UV coatings have been widely developed due to excellent performance, instant curing, space saving, energy saving, and environmental friendliness. The commonly-used curing light sources for UV coatings, including mercury lamps and gallium lamps, may generate a large amount of heat during use, limiting applications of the UV coatings on heat-sensitive materials such as thin-film materials. PCT/CN2019/120508 provided a multi-layer and radiation-cured pre-coating film and a preparation method thereof. The pre-coating film includes a flexible transparent film layer and a radiation-cured coating layer. However, the pre-coating film lacks color and three-dimensional pattern effects.

### SUMMARY

The present disclosure aims to provide a composite pre-coating film that is scratch-resistant, wear-resistant, and stain-resistant and has a three-dimensional pattern effect, and further prepares a composite floor with an excellent comprehensive performance.

In view of some problems existing in the prior art, a first aspect of the present disclosure provides a preparation method of a composite pre-coating film, including the following step: laminating a polymeric printing film, a polymeric transparent film, and a radiation-cured coating A in sequence.

In an example, the polymeric transparent film may have a thickness of 0.1 mm to 1 mm, such as 0.1 mm, 0.15 mm, 0.2 mm, 0.25 mm, 0.3 mm, 0.35 mm, 0.4 mm, 0.5 mm, 0.55 mm, 0.6 mm, 0.65 mm, 0.7 mm, 0.75 mm, 0.8 mm, 0.9 mm, and 1 mm.

In the present disclosure, there is no special limitation on the polymeric transparent film, and preferably one selected from the group consisting of a polyvinyl chloride (PVC) film, a polypropylene (PP) film, and a polyethylene terephthalate glycol (PETG) film may be used.

In an example, the polymeric transparent film and the polymeric printing film may be prepared form a same material.

In an example, a preparation method of the composite pre-coating film may include the following steps:
(1) coating the radiation-cured coating A on the polymeric transparent film to obtain a pre-coating film; and
(2) attaching the polymeric printing film with a polymeric transparent film side of the pre-coating film under the action of an embossing roller to obtain the composite pre-coating film.

In an example, step (1) may include: coating a finishing coat on the polymeric transparent film, or coating a radiation-cured adhesion primer and the finishing coat in sequence on the polymeric transparent film.

In the present disclosure, the adhesion primer may be specifically selected by those skilled in the art according to the polymeric transparent film, such that the adhesion primer has desirable adhesion with the polymeric transparent film. The adhesion primer may have a coating thickness of preferably 2 g/m² to 20 g/m², more preferably 3 g/m² to 15 g/m².

In an example, the adhesion primer may be cured by one or more light sources selected from the group consisting of a light-emitting diode (LED), a mercury lamp, and a gallium lamp, preferably the LED. It is unexpectedly found that in the present disclosure, when curing by the LED, the polymeric transparent film has no deformation, avoiding deformation under the heat emitted by the mercury lamp or the gallium lamp. The LED curing may be preferably UV-LED curing.

In an example, when the adhesion primer may be cured by the mercury lamp or the gallium lamp, the polymeric transparent film is cooled by a cooling device while curing.

In the present disclosure, the finishing coat has desirable scratch resistance, abrasion resistance, stain resistance, and flexibility, which can be routinely selected by those skilled in the art.

In an example, the finishing coat may be cured by a combined light source containing an excimer lamp-based curing device.

Preferably, the finishing coat may be cured by an MEC combined light source system.

In the present disclosure, the finishing coat is cured by the combined light source containing an excimer lamp-based curing device. The light source has low heat generation; and the cured finishing coat has a better scratch resistance and a wear resistance, which is easy to form a matte coating and avoids deformation of the polymeric transparent film.

In an example, in step (2), the laminating may be conducted at 100° C. to 250° C.

In an example, in step (2), the laminating may be conducted for 10 sec to 5 min.

The lamination temperature and the lamination time are determined according to the characteristics of a lamination material and a production rate. A higher melting point of the lamination material leads to a higher lamination temperature. For the same material, the lamination time is short at a high temperature, and the lamination effect can be achieved at a low temperature and a long time.

In a preferred example, when the polymeric transparent film and the polymeric printing film each are a PVC film, the lamination temperature may be 120° C. to 180° C., such as 120° C., 125° C., 130° C., 135° C., 140° C., 145° C., 150° C., 155° C., 160° C., 165° C., 170° C., 175° C., and 180° C.

In a preferred example, when the polymeric transparent film and the polymeric printing film each are a PP film, the lamination temperature may be 140° C. to 200° C., such as 140° C., 145° C., 150° C., 155° C., 160° C., 165° C., 170° C., 180° C., 190° C., and 200° C.

In a preferred example, when the polymeric transparent film and the polymeric printing film each are a PETG film, the lamination temperature may be 180° C. to 200° ° C., such as 180° C., 185° C., 190° C., 195° C., and 200° C.

In the present disclosure, the embossing roller is a roller with patterns, such as wood patterns, stone patterns, carpet patterns, leather patterns, and cloth patterns.

In an example, an embossing depth may be 0.1 mm to 1 mm.

In an example, step (1) may include: coating only one streak of the finishing coat on the polymeric transparent film; the finishing coat has desirable adhesion as well as scratch resistance, abrasion resistance, stain resistance, and flexibility, which can be selected by those skilled in the art. The finishing coat may have a coating thickness of preferably 3 g/m² to 30 g/m², more preferably 5 g/m² to 20 g/m².

In an example, step (1) may include: coating a radiation-cured adhesion primer and the finishing coat in sequence on the polymeric transparent film. The adhesion primer may have a coating thickness of preferably 2 g/m² to 20 g/m², more preferably 3 g/m² to 15 g/m². The finishing coat may have a coating thickness of preferably 3 g/m² to 30 g/m², more preferably 5 g/m² to 20 g/m².

In an example, step (1) may include: coating the radiation-cured adhesion primer, a middle coating, and the finishing coat on the polymeric transparent film in sequence.

In the present disclosure, a type of the adhesion primer can be specifically selected by those skilled in the art according to a type of the polymeric transparent film, such that the adhesion primer has desirable adhesion with the polymeric transparent film. The adhesion primer may have a coating thickness preferably 2 g/m² to 20 g/m², more preferably 3 g/m² to 15 g/m². The finishing coat has desirable scratch resistance, abrasion resistance, stain resistance, and flexibility, which can be routinely selected by those skilled in the art. The finishing coat may have a coating thickness of preferably 3 g/m² to 30 g/m², more preferably 5 g/m² to 20 g/m².

In the present disclosure, the middle coating may be a radiation-cured primer with desirable flexibility and wear resistance, and may have a coating thickness of preferably 10 g/m² to 300 g/m², more preferably 20 g/m² to 250 g/m².

In the present disclosure, the middle coating may include preferably the following raw materials in parts by weight:
10 parts to 80 parts, preferably 20 parts to 70 parts of di-functionality polyurethane acrylate resin;
20 parts to 60 parts, preferably 40 parts to 50 parts of multi-functionality polyurethane acrylate resin;
0 parts to 30 parts, preferably 5 parts to 20 parts of a reactive diluent;
0 parts to 5 parts, preferably 1 part to 4 parts of a photoinitiator; and
0 parts to 40 parts, preferably 10 parts to 30 parts of wear-resistant particles.

In the present disclosure, there is no special limitation on the reactive diluent, and those skilled in the art can make specific selections according to requirements; and preferably a mono-functionality reactive diluent and/or a bi-functionality reactive diluent can be used.

In the present disclosure, there is no special limitation on the photoinitiator, and those skilled in the art can make specific selections according to requirements.

In an example, the wear-resistant particles may be one or more selected from the group consisting of an alumina micropowder, a diamond micropowder, a silicon carbide micropowder, a silicon micropowder, and a nepheline powder.

In an example, the di-functionality polyurethane acrylate resin may have a molecular weight of 1,500 to 10,000, a Tg of −60° C. to 15° C., and an elongation of greater than or equal to 50%; the multi-functionality polyurethane acrylate resin may have a functionality of greater than 2, a molecular weight of 1,500 to 10,000, and a Tg of greater than 50° C.

In an example, the middle coating may be cured by one or more light sources selected from the group consisting of a UV-LED, a mercury lamp, and a gallium lamp, preferably the UV-LED. When the middle coating is cured by the mercury lamp or the gallium lamp, the polymeric transparent film is cooled while curing.

In an example, the finishing coat may be cured by one or a combination of two or more light sources selected from the group consisting of a gallium lamp, a mercury lamp, a UV-LED lamp, a halogen lamp, a light source containing an excimer lamp, and a light source with a wavelength of 254 nm.

In an example, when the polymeric transparent film and the polymeric printing film each are a PVC film, the PVC film includes preferably a plasticizer. The plasticizer can significantly improve a flexibility of the PVC film and reduce a heat distortion temperature, and can also reduce a three-dimensional effect of the embossing; in addition, the plasticizer is a small-molecule organic compound, which may precipitate during the high-temperature lamination, resulting in a decreased bonding force between the coating and the PVC film. In order to solve this problem, when the polymeric transparent film and the polymeric printing film each are a PVC film, the composite pre-coating film includes a printing PVC film, a flexible transparent PVC film, a rigid transparent PVC film, and a radiation-cured coating A that are laminated in sequence.

In the present disclosure, when the polymeric transparent film and the polymeric printing film each are a PVC film, a preparation method of the composite pre-coating film may include preferably the following steps:
coating the radiation-cured coating A on a rigid transparent PVC film to obtain a pre-coating film; and
laminating a printing PVC film, a flexible transparent PVC film, and a rigid transparent PVC film side of pre-coating film in sequence, and laminating under the action of the embossing roller to obtain the composite pre-coating film.

In the present disclosure, the rigid transparent PVC film may have a thickness of preferably 20 μm to 200 μm, more preferably 30 μm to 100 μm. The rigid transparent PVC film may have preferably 0% to 10%, more preferably 0% to 5% of the plasticizer by mass content. In some preferred examples, the rigid transparent PVC film may further include preferably 0% to 10%, more preferably 1% to 5% of a toughening agent. There is no special limitation on the toughening agent, and those skilled in the art can make selections according to requirements, such as NBR, CPE, EVA, ABS, and MBS.

In the present disclosure, the flexible transparent PVC film may include preferably 25% to 40% of the plasticizer by mass content. There is no special limitation on a thickness of the flexible transparent PVC film, and those skilled in the art can make selections according to requirements, such as 100 μm, 150 μm, 200 μm, 250 μm, and 300 μm.

In the present disclosure, the rigid transparent PVC film is used to compound the flexible transparent PVC film to avoid plasticizer precipitation of the pre-coating PVC film during the high-temperature lamination, while ensuring the flexibility of the PVC film. Since the embossing is conducted on one side of the rigid PVC film, the embossing has a strong three-dimensional effect and is beautiful and realistic.

The present disclosure further provides a composite pre-coating film prepared by the preparation preparing of the composite pre-coating film.

The present disclosure further provides use of the composite pre-coating film in floors, furniture, and decorative sheets.

In an example, a polymeric printing film side of the composite pre-coating film may be laminated on a surface of a substrate by the action of an adhesive.

In an example, the adhesive may be a two-component polyurethane adhesive and/or a PUR adhesive.

In an example, the substrate may be any one selected from the group consisting of the flooring, the furniture, and the decorative sheets.

In the present disclosure, the floors may include plastic floors, solid wood floors, and composite floors; the furniture may be prepared from density boards, particle boards, composite boards, solid wood boards, and multi-layer solid wood boards; and the decorative sheets may include inorganic sheets and composite sheets.

A second aspect of the present disclosure is to provide a composite floor, including a solid wood substrate layer, an adhesive layer, and a layer of the composite pre-coating film sequentially, where the composite pre-coating film includes a polymeric printing film, a polymeric transparent film, and a radiation-cured coating A that are laminated in sequence.

In an example, the solid wood substrate layer may be a single-layer solid wood substrate or a multi-layer solid wood substrate.

In the present disclosure, there is no special limitation on the single-layer solid wood substrate, and those skilled in the art can make selections according to requirements, such as a solid wood veneer or solid wood finger-joint substrate.

In the present disclosure, there is no special limitation on the multi-layer solid wood substrate, and those skilled in the art can make selections according to requirements, including a three-layer solid wood substrate, a five-layer solid wood substrate, a seven-layer solid wood substrate, or an even-numbered-layer solid wood substrate that meets the balance of thermal expansion and contraction.

In an example, in order to prepare a more cost-effective composite floor, a surface plate flatness of the multi-layer solid wood substrate may only need to meet the requirements of an adhesive to bond the composite pre-coating film. The multi-layer solid wood substrate has wood knot holes or holes of preferably less than or equal to 0.5 mm, and a width of wood cracks of preferably less than or equal to 0.2 mm.

In an example, in the multi-layer solid wood substrate, an arrangement direction of the surface plates may be parallel or perpendicular to a pattern direction of the composite pre-coating film. An arrangement direction of core plates under the surface plate is preferably parallel to a direction of the composite pre-coating film, to ensure flatness and stability of the surface after the adhesive is applied; that is, when the multi-layer solid wood substrate is deformed due to changes in temperature and humidity, the surface composite pre-coating film has no obvious defects such as horizontal stamps and cracks.

In an example, the adhesive may be a two-component polyurethane adhesive or a PUR adhesive.

In an example, the polymeric printing film is preferably a printing PVC film, and the polymeric transparent film is preferably a transparent PVC film.

A third aspect of the present disclosure is to provide a preparation method of a composite floor, including the following steps:
laminating the polymeric printing film side of the composite pre-coating film on a surface of the solid wood substrate through an adhesive, and forming the adhesive layer by the adhesive to obtain the composite floor.

In the present disclosure, the composite floor is referred to as Wood Plastic Laminate Floor (WPL Floor).

In the present disclosure, the solid wood substrate is coated with the composite pre-coating film at one side, and preferably coated with a UV back coating at the other side. There is no special limitation on the UV back coating, and those skilled in the art can make selections according to requirements.

In another example, a preparation method of the composite floor includes the following steps:
laminating the polymeric printing film and the polymeric transparent film under the action of the embossing roller to obtain a composite polymer film; and
laminating the polymeric printing film side of the composite polymer film on the surface of the solid wood substrate through the adhesive, and coating the radiation-cured coating A on the polymeric transparent film side of the composite polymer film to obtain the composite floor.

In the present disclosure, a method for applying the radiation-cured coating A is the same as the method for applying the radiation-cured coating A when preparing the composite pre-coating film, and details are not repeated here.

In an example, the preparation method may further include preferably slicing and tongue-and-groove treatment on the composite floor.

In an example, the solid wood substrate is coated with the composite pre-coating film at one side, and preferably attached with a foaming polymer material-based silence pad at the other side, to achieve muting and noise reduction; there is no special limitation on the silence pad, and those skilled in the art can make selections according to requirements.

In an example, the preparation method may further include conducting waterproofing treatment on the composite floor; and the waterproofing treatment includes: sealing the composite floor after the tongue-and-groove treatment with wax or applying a waterproof coating.

In an example, the waterproof coating is preferably a water-based coating, a wax oil, or a UV coating.

Alternatively, the waterproofing treatment includes: splicing the composite floor after the tongue-and-groove treatment, and applying a joint glue at the splicing part. There is no special limitation on the joint glue, and those skilled in the art can make selections according to requirements, as long as the joint glue has desirable adhesion to the solid wood substrate and has a high waterproof effect.

Compared with the prior art, the present disclosure has the following beneficial effects:
(1) In the present disclosure, the composite pre-coating film has multiple functions through a composite structure design. The radiation-cured coating provides a desirable abrasion and scratch resistance and gloss; the polymeric transparent film is flexible and resistant to abrasion; and the polymeric printing film provides a color pattern effect. After being embossed by an embossing roller, the composite pre-coating film has a three-dimensional simulated pattern effect, as well as excellent wear resistance, scratch resistance, and stain resistance.
(2) In the present disclosure, the composite pre-coating film combines the advantages of the radiation-cured coating and the polymeric transparent film, improves the wear resistance, scratch resistance, and stain resistance of the decorative film, improves a grade of the decorative film, and broadens an application range of the decorative film.
(3) In the present disclosure, the composite pre-coating film can be prepared into three-dimensional and simulated film materials with a variety of styles through a design of the embossing roller combined with color and pattern of the printing film, thereby obtaining a composite floor with various wood-plastic structures (WPL Floor).
(4) In the present disclosure, the preparation method of the composite pre-coating film is simple, with lamination and embossing being completed in one step, thereby simplifying the existing production process to facilitate mass production. Moreover, the decorative films with a three-dimensional simulation effect are directly prepared, such that subsequent embossing is omitted; and the decorative films can be widely used in the fields of floors, furniture, decorative boards and the like by applying on the substrate by adhesives.
(5) In the present disclosure, the composite floor combines many advantages of the plastic floor, laminate floor, and solid wood floor, and has a strong structural stability, comfortable foot feeling, safety and environmental friendliness, and superior performance. The composite floor also breaks through defects of formaldehyde containing in the laminate floors, chromatic aberration of the solid wood floors leading to complex coating, and poor structural stability of the plastic floors and the laminate floors.
(6) In the present disclosure, the composite floor is cost-effective, simple in the production technology, and environmental-friendly in the production process, and does not release harmful substances such as formaldehyde and total volatile organic compounds (TVOCs). The preparation method has a wide range of uses, such as furniture, decorative sheets and other fields.

### DETAILED DESCRIPTION OF THE EMBODIMENTS

### Example 1

A preparation method of a composite pre-coating film included the following steps:
(1) a radiation-cured adhesion primer and a finishing coat were coated in sequence on a transparent PVC film with a thickness of 0.1 mm, to obtain a pre-coating film;
(2) a printing PVC film and a PVC film side of the pre-coating film were laminated under the action of an embossing roller at 130° C. for 3 min, to obtain a composite pre-coating film; and
(3) a polymeric printing film side of the composite pre-coating film was attached on a surface of a plastic floor by the action of a two-component polyurethane adhesive.

In step (1), the adhesion primer was cured by an LED lamp, and the finishing coat was cured by a combination light source including an excimer lamp-based curing device.

The embossing roller had a wood pattern as the embossing, with an embossing depth of 0.1 mm.

In this example, a composite pre-coating film prepared by the preparation method of a composite pre-coating film was further provided.

In this example, use of the composite pre-coating film was further provided in floors, furniture, and decorative sheets.

### Example 2

A preparation method of a composite pre-coating film included the following steps:
(1) a radiation-cured adhesion primer and a finishing coat were coated in sequence on a transparent PP film with a thickness of 1 mm, to obtain a pre-coating film;
(2) a printing PP film and a PP film side of the pre-coating film were laminated under the action of an embossing roller at 150° C. for 3 min, to obtain a composite pre-coating film; and
(3) a polymeric printing film side of the composite pre-coating film was attached on a surface of a solid wood floor by the action of a two-component polyurethane adhesive.

In step (1), the adhesion primer was cured by an LED lamp, and the finishing coat was cured by a combination light source including an excimer lamp-based curing device.

The embossing roller had a stone pattern as the embossing, with an embossing depth of 0.5 mm.

In this example, a composite pre-coating film prepared by the preparation method of a composite pre-coating film was further provided.

In this example, use of the composite pre-coating film was further provided in floors, furniture, and decorative sheets.

### Example 3

A preparation method of a composite pre-coating film included the following steps:
(1) a radiation-cured adhesion primer and a finishing coat were coated in sequence on a transparent PETG film with a thickness of 0.5 mm, to obtain a pre-coating film;
(2) a printing PETG film and a PETG film side of the pre-coating film were laminated under the action of an embossing roller at 180° C. for 3 min, to obtain a composite pre-coating film; and
(3) a polymeric printing film side of the composite pre-coating film was attached on a surface of a solid wood floor by the action of a two-component polyurethane adhesive.

In step (1), the adhesion primer was cured by an LED lamp, and the finishing coat was cured by a combination light source including an excimer lamp-based curing device.

The embossing roller had a leather pattern as the embossing, with an embossing depth of 0.3 mm.

In this example, a composite pre-coating film prepared by the preparation method of a composite pre-coating film was further provided.

In this example, use of the composite pre-coating film was further provided in floors, furniture, and decorative sheets.

### Example 4

A preparation method of a composite pre-coating film was the same as that in Example 1, except that: in step (2), the printing PVC film and the PVC film side of the pre-coating film were laminated at 180° C. for 10 sec under the action of the embossing roller, to obtain a composite pre-coating film.

### Example 5

A preparation method of a composite pre-coating film was the same as that in Example 1, except that: in step (2), the printing PVC film and the PVC film side of the pre-coating film were laminated at 175° C. for 7 min under the action of the embossing roller, to obtain a composite pre-coating film. The composite pre-coating film showed an obvious yellowing phenomenon.

### Example 6

A preparation method of a composite pre-coating film was the same as that in Example 1, except that: in step (2), the printing PVC film and the PVC film side of the pre-coating film were laminated at 100° C. for 3 min under the action of the embossing roller, to obtain a composite pre-coating film. The composite pre-coating film had insufficient bonding fastness and did not form a whole, such that the printing PVC film and the pre-coating film were easily peeled off.

### Example 7

A preparation method of a composite pre-coating film included the following steps:
(1) a radiation-cured finishing coat was coated on a rigid transparent PVC film with a thickness of 50 μm, to obtain a pre-coating film, where the rigid transparent PVC film had 1% of a plasticizer and 4% of a toughening agent MBS;
(2) the printing PVC film, a flexible transparent PVC film, and the PVC film side of the pre-coating film were laminated in sequence, and laminated at 130° C. for 3 min under the action of the embossing roller, to obtain a composite pre-coating film, where the flexible transparent PVC film had a thickness of 250 μm and a plasticizer content of 30%; and
(3) a polymeric printing film side of the composite pre-coating film was attached on a surface of a plastic floor by the action of a two-component polyurethane adhesive.

In step (1), the finishing coat was cured with a mercury lamp.

The embossing roller had a wood pattern as the embossing, with an embossing depth of 0.5 mm.

In this example, a composite pre-coating film prepared by the preparation method of a composite pre-coating film was further provided.

In this example, use of the composite pre-coating film was further provided in floors, furniture, and decorative sheets.

### Example 8

A preparation method of a composite pre-coating film included the following steps:
(1) a radiation-cured adhesion primer, middle coating, and finishing coat were coated in sequence on a rigid transparent PVC film with a thickness of 50 μm, to obtain a pre-coating film, where the rigid transparent PVC film had 1% of a plasticizer and 4% of a toughening agent MBS;
(2) the printing PVC film, a flexible transparent PVC film, and the PVC film side of the pre-coating film were laminated in sequence, and laminated at 130° C. for 3 min under the action of the embossing roller, to obtain a composite pre-coating film, where the flexible transparent PVC film had a thickness of 250 μm and a plasticizer content of 30%; and
(3) a polymeric printing film side of the composite pre-coating film was attached on a surface of a plastic floor by the action of a two-component polyurethane adhesive.

In step (1), the radiation-cured adhesion primer had a thickness of 5 g/m², the radiation-cured middle coating had a thickness of 80 g/m², and the radiation-cured finishing coat had a thickness of 10 g/m². The radiation-cured adhesion primer was cured by a gallium lamp, and the transparent PVC film was cooled by a cooling equipment while curing; the middle coating was cured by a UV-LED lamp; and the finishing coat was cured by a combination light source containing an excimer lamp-based curing device.

The embossing roller had a wood pattern as the embossing, with an embossing depth of 0.5 mm.

In this example, a composite pre-coating film prepared by the preparation method of a composite pre-coating film was further provided.

In this example, use of the composite pre-coating film was further provided in floors, furniture, and decorative sheets.

### Example 9

A preparation method of a composite floor (WPL Floor) included the following steps:

A three-layer solid wood substrate was polished and levelled; a polymeric printing film side of the composite pre-coating film in Example 1 was attached on a surface of the three-layer solid wood substrate by the action of a PUR adhesive, and then a back side of the substrate was coated with a UV back coating; curing, slicing, and tongue-and-groove treatment were conducted, and a water-based coating was coated on a side opening of the substrate for waterproof treatment, to obtain the composite floor (WPL Floor).

### Example 10

A preparation method of a composite floor (WPL Floor) included the following steps:

A five-layer solid wood substrate was polished and levelled; a polymeric printing film side of the composite pre-coating film in Example 8 was attached on a surface of the five-layer solid wood substrate by the action of a PUR adhesive; slicing and tongue-and-groove treatment were conducted, and a water-based coating was coated on a side opening of the substrate for waterproof treatment, and a foaming polymer material-based silence pad was attached on a back side of the substrate, to obtain the composite floor (WPL Floor).

### Example 11

A preparation method of a composite floor (WPL Floor) included the following steps:
(1) The printing PVC film and the transparent PVC film with a thickness of 0.3 mm were laminated at 140° C. for 1 min under the action of an embossing roller, to obtain a composite PVC film.
(2) A printing film side of the composite PVC film was attached to a surface of a seven-layer solid wood substrate through a PUR adhesive.
(3) A radiation-cured adhesion primer and a finishing coat were coated in sequence on a transparent film side of the composite PVC film.
(4) The slicing and tongue-and-groove treatment were conducted, and a water-based coating was coated on a side opening of the substrate for waterproof treatment, and a foaming polymer material-based silence pad was attached on a back side of the substrate, to obtain the composite floor (WPL Floor).

In step (1), the adhesion primer was cured by a mercury lamp, and the finishing coat was cured by a combination light source including an excimer lamp-based curing device.

The embossing roller had a wood pattern as the embossing, with an embossing depth of 0.1 mm.

The above descriptions are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

1. A preparation method of a composite pre-coating film, comprising the following step: laminating a polymeric printing film, a polymeric transparent film, and a radiation-cured coating A in sequence.

2. The preparation method according to claim 1, wherein the polymeric transparent film is any one selected from the group consisting of a polyvinyl chloride (PVC) film, a polypropylene (PP) film, and a polyethylene terephthalate glycol (PETG) film.

3. The preparation method according to claim 2, wherein the polymeric transparent film and the polymeric printing film are prepared form a same material.

4. The preparation method according to claim 1, comprising the following steps:
(1) coating the radiation-cured coating A on the polymeric transparent film to obtain a pre-coating film; and
(2) attaching the polymeric printing film to a polymeric transparent film side of the pre-coating film under the action of an embossing roller to obtain the composite pre-coating film.

5. The preparation method according to claim 4, wherein step (1) comprises: coating a finishing coat on the polymeric transparent film, or coating a radiation-cured adhesion primer and the finishing coat in sequence on the polymeric transparent film; alternatively, step (1) comprises: coating the radiation-cured adhesion primer, a middle coating, and the finishing coat on the polymeric transparent film in sequence.

6. The preparation method according to claim 5, wherein the adhesion primer is cured by one or more light sources selected from the group consisting of a light-emitting diode (LED), a mercury lamp, and a gallium lamp.

7. The preparation method according to claim 5, wherein the finishing coat is cured by one or a combination of two or more light sources selected from the group consisting of a gallium lamp, a mercury lamp, a ultraviolet light-emitting diode (UV-LED) lamp, a halogen lamp, a light source containing an excimer lamp, and a light source with a wavelength of 254 nm.

8. The preparation method according to claim 5, wherein the adhesion primer has a coating thickness of preferably 2 g/m² to 20 g/m², the finishing coat has a coating thickness of 3 g/m² to 30 g/m², and the middle coating has a coating thickness of 10 g/m² to 300 g/m².

9. The preparation method according to claim 5, wherein the middle coating comprises the following raw materials in parts by weight: 10 parts to 80 parts of di-functionality polyurethane acrylate resin, 20 parts to 60 parts of multi-functionality polyurethane acrylate resin, 0 parts to 30 parts of a reactive diluent, 0 parts to 5 parts of a photoinitiator, and 0 parts to 40 parts of wear-resistant particles; and the multi-functionality polyurethane acrylate resin has a functionality of greater than 2.

10. The preparation method according to claim 5, wherein when the polymeric transparent film and the polymeric printing film each are a PVC film, a preparation method of the composite pre-coating film comprises the following steps:
coating the radiation-cured coating A on a rigid transparent PVC film to obtain a pre-coating film; and
laminating a printing PVC film, a flexible transparent PVC film, and a rigid transparent PVC film side of the pre-coating film in sequence, and conducting attachment under the action of the embossing roller to obtain the composite pre-coating film.

11. The preparation method according to claim 10, wherein the rigid transparent PVC film has a thickness of 20 μm to 200 μm, and has 0% to 10% of a plasticizer by mass content; and the flexible transparent PVC film has 25% to 40% of the plasticizer by mass content.

12. A composite pre-coating film prepared by the preparation method according to claim 1, comprising a polymeric printing film, a polymeric transparent film, and a radiation-cured coating A that are laminated in sequence.

13. A composite floor, comprising a solid wood substrate layer, an adhesive layer, and a layer of the composite pre-coating film according to claim 12 in sequence.

14. The composite floor according to claim 13, wherein the solid wood substrate layer comprises a single-layer solid wood substrate or a multi-layer solid wood substrate.

15. The composite floor according to claim 13, wherein the solid wood substrate is coated with the composite pre-coating film at one side, and then coated with a UV back coating at the other side.

16. The composite floor according to claim 13, wherein the solid wood substrate is coated with the composite pre-coating film at one side, and then attached with a foaming polymer material-based silence pad at the other side.

17. (canceled)

18. A preparation method of the composite floor according to claim 13, comprising the following steps:
laminating the polymeric printing film and the polymeric transparent film under the action of the embossing roller to obtain a composite polymer film; and
laminating the polymeric printing film side of the composite polymer film on the surface of the solid wood substrate through the adhesive, and coating the radiation-cured coating A on the polymeric transparent film side of the composite polymer film to obtain the composite floor.

19. (canceled)

20. (canceled)

21. The composite pre-coating film according to claim 12, wherein the polymeric transparent film is any one selected from the group consisting of a polyvinyl chloride (PVC) film, a polypropylene (PP) film, and a polyethylene terephthalate glycol (PETG) film.

22. The composite pre-coating film according to claim 12, comprising the following steps:
(1) coating the radiation-cured coating A on the polymeric transparent film to obtain a pre-coating film; and
(2) attaching the polymeric printing film to a polymeric transparent film side of the pre-coating film under the action of an embossing roller to obtain the composite pre-coating film.

23. The composite pre-coating film according to claim 22, wherein step (1) comprises: coating a finishing coat on the polymeric transparent film, or coating a radiation-cured adhesion primer and the finishing coat in sequence on the polymeric transparent film; alternatively, step (1) comprises: coating the radiation-cured adhesion primer, a middle coating, and the finishing coat on the polymeric transparent film in sequence.
